(19) United States
(12) Patent Application Publication
(10) Pub. No.: US 2015/0379199 A1
(43) Pub. Date: Dec. 31, 2015

(54) USER-BASED REMOTE CAPTURING OF HEALTH AND MEDICAL RELATED DATA

(71) Applicant: Access My Records, Inc., Boca Raton, FL (US)

(72) Inventor: Leonard J. TAMBASCO, JR., Boca Raton, FL (US)

(21) Appl. No.: 14/314,118

(22) Filed: Jun. 25, 2014

(51) Int. Cl. G06F 19/00; H04N 5/44; H04N 7/18

(52) U.S. Cl. CPC G06F 19/322; H04N 7/18; H04N 5/44

(57) ABSTRACT

Various embodiments remotely capture health-related information. In one embodiment at least one image of an object comprising health-related information associated with a user is captured with an image capturing device communicatively coupled to an information processing system associated with the user. At least one data item is extracted from the image. The at least one data item comprises health-related information associated with the user. The data item is identified as being one of patient identifying information, healthcare provider and facility information, and health and medical related information. A message is generated that comprises the at least one data item and an indication that the data item is one of patient identifying information, healthcare provider and facility information, and health and medical related information. The generated message is transmitted to a health care patient portal.

### BACKGROUND

The present disclosure generally relates to the electronic management of health/medical records, and more particularly relates to user-based remote capturing of health and medical related data.

Healthcare providers have traditionally maintained all of their patients' information in paper filing systems. However, this practice is very inefficient and lends itself to poor management practices of the patient's data. Accordingly, Electronic Health Management Systems (EHMS) have been developed to provide many of the functionalities and features of paper filing systems in an electronic paperless format. These systems streamline workflow processes and clinical, financial, and administrative information. Electronic Health Management Systems also improve coding and billing accuracy. However, patients generally do not have access to EHMSs to manage and provide their health-related data.

### BRIEF SUMMARY

In one embodiment, a method for remotely capturing health-related information is disclosed. The method comprises capturing at least one image of an object comprising health-related information associated with a user. The image is captured with an image capturing device communicatively coupled to an information processing system associated with the user. At least one data item is extracted from the image. The at least one data item comprises health-related information associated with the user. The data item is identified as being one of patient identifying information, healthcare provider and facility information, and health and medical related information. A communication is generated that comprises the at least one data item and an indication that the data item is one of patient identifying information, healthcare provider and facility information, and health and medical related information. The generated communication is transmitted to a health care patient portal.

In another embodiment, an information processing system for remotely capturing health-related information is disclosed. The information processing system comprises memory and a processor that is communicatively coupled to the memory. The information processing system further comprises a health care patient portal interface that communicatively coupled to the memory and the processor. The health care patient portal interface is configured to perform a method. The method comprises capturing at least one image of an object comprising health-related information associated with a user. The image is captured with an image capturing device communicatively coupled to the information processing system. At least one data item is extracted from the image. The at least one data item comprises health-related information associated with the user. The data item is identified as being one of patient identifying information, healthcare provider and facility information, and health and medical related information. A communication is generated that comprises the at least one data item and an indication that the data item is one of patient identifying information, healthcare provider and facility information, and health and medical related information. The generated communication is transmitted to a health care patient portal.

In yet another embodiment, a computer program storage product for remotely capturing health-related information is disclosed. The computer program storage product comprising instructions configured to perform a method. The method comprises capturing at least one image of an object comprising health-related information associated with a user. The image is captured with an image capturing device communicatively coupled to the information processing system. At least one data item is extracted from the image. The at least one data item comprises health-related information associated with the user. The data item is identified as being one of patient identifying information, healthcare provider and facility information, and health and medical related information. A communication is generated that comprises the at least one data item and an indication that the data item is one of patient identifying information, healthcare provider and facility information, and health and medical related

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 is a block diagram illustrating a detailed view of a patient portal manager according to one embodiment of the present disclosure;

FIG. 3 shows one example of an electronic record according to one embodiment of the present disclosure;

FIG. 4 shows a more detailed view of a patient portal interface according to one embodiment of the present disclosure;

FIG. 5 shows one example of a patient portal interface displaying an image capturing screen for capturing an object with health-related information according to one embodiment of the present disclosure;

FIG. 6 shows one example of the structure and format of a continuity of care document (CCD);

FIG. 7 shows one example of a user profile for a patient portal according to one embodiment of the present disclosure;

FIG. 8 is an operational flow diagram illustrating one example of an overall process for automatically generating a patient presence for a patient portal according to one embodiment of the present disclosure;

FIG. 9 is a block diagram illustrating one example of an information processing system according to one embodiment of the present disclosure; and

FIG. 10 is a block diagram illustrating one example of a portable electronic device according to one embodiment of the present disclosure.

### DETAILED DESCRIPTION

Operating Environment

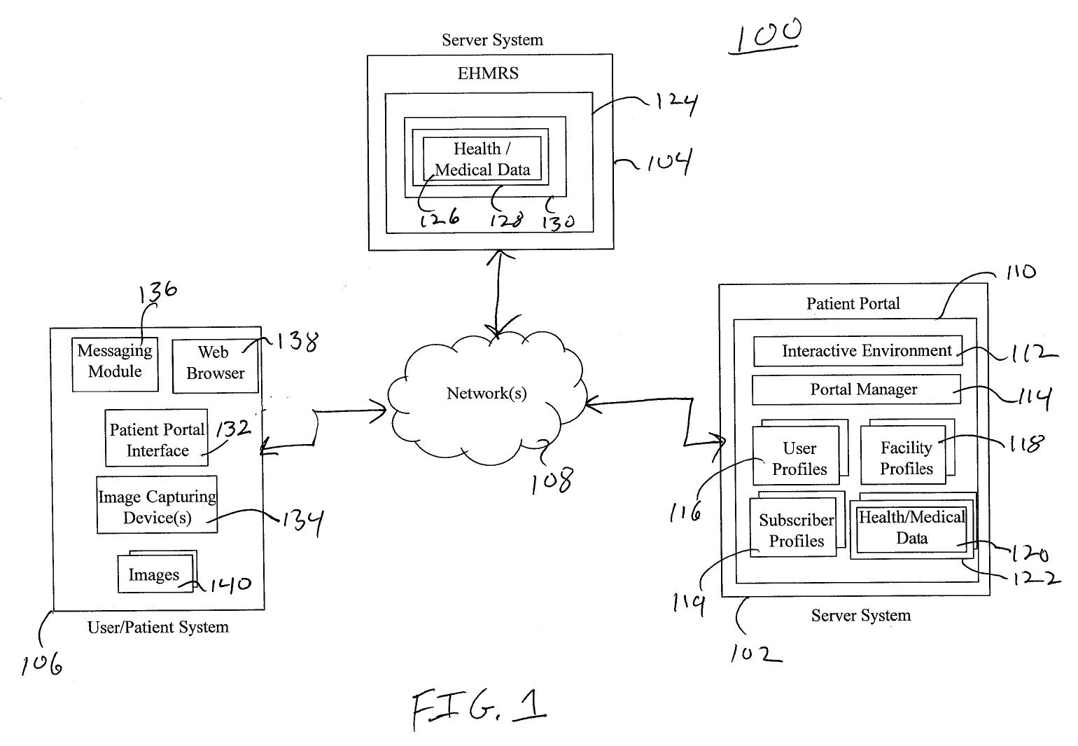

FIG. 1 illustrates one example of an operating environment 100 according to one embodiment of the present disclosure. The operating environment 100, in this embodiment, comprises a plurality of information processing systems 102, 104, 106 communicatively coupled to one or more networks 108. The information processing systems 102, 104, 106 comprise server systems, user systems, and/or the like. Examples of user systems include (but are not limited to) desktop computers; servers; portable computing devices such as laptop computers mobile/smart phones, tablets, wearable computing devices (e.g., smart watches), personal digital assistants, etc.; and the like. In one embodiment, one or more of the information processing systems 102, 104, 106 are part of a cloud-computing environment or a non-cloud computing environment.

The network(s) 108 comprises a local area network (LAN), a general wide area network (WAN), and/or a public network (e.g., the Internet). The network(s) 108, in one embodiment, also comprises a wireless communication network that supports any wireless communication standard such as, but not limited to, a Wireless Fidelity (WiFi) network, Global System for Mobile Communications (GSM), Code Division Multiple Access (CDMA), Time Division Multiple Access (TDMA), General Packet Radio Service (GPRS), Frequency Division Multiple Access (FDMA), Orthogonal Frequency Division Multiplexing (OFDM), or the like. The wireless communication network includes one or more networks based on such standards. For example, in one embodiment, the wireless communication network comprises one or more of a Long Term Evolution (LTE) network, LTE Advanced (LTE-A) network, an Evolution Data Only (EV-DO) network, a GPRS network, a Universal Mobile Telecommunications System (UMTS) network, and the like.

At least one system 102 comprises a patient portal 110. The patient portal 110 is a healthcare-related website and/or online application (e.g., a cloud-based application) or service (e.g., a cloud-based service) that allows users/patients to securely manage and view their health and medical-related information created by one or more healthcare providers such as physicians and hospitals. It should be noted that throughout this disclosure health-related information comprising medial-related information and medical-related information comprised health-related information unless otherwise noted. One example of a patient portal 110 is provided in the co-pending U.S. patent application Ser. No. ______, entitled “Electronic Management Of Patient Health Care Data” filed on ______, which is hereby incorporated by reference in its entirety.

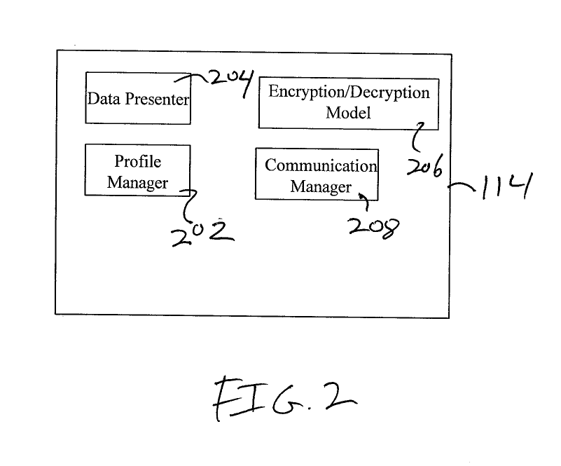

The patient portal 110 also allows a registered user/patient to securely interact and communicate with their healthcare providers. In one embodiment, the patient portal 110 comprises an interactive environment 112 and a patient portal manager 114. The patient portal manager 114 comprises a profile manager 202 (FIG. 2), a data presenter 204, an optional data encryption/decryption module 206, and a communication manager 208. The patient portal 110 further comprises user profiles 116, facility profiles 118, subscriber profiles 119, and user health/medical data 120 stored within one more electronic records 122. However, one or more of these profiles 116, 118 and health/medical data 120 can be stored outside of the patient portal 110 on the server system 102 and/or on or across one or more remote information processing systems.

In one embodiment, the patient portal 110 receives patient identifying and health/medical-related information from one or more electronic record management system such as an Electronic Health Management System (EHMS) 124. An EHMS 124 comprises and/or is based on, for example, Electronic Medical Record (EMR) Systems, Electronic Health Record (EHR) Systems, Personal Health Record (PHR) Systems, Practice Management Software Systems, Health Information Exchanges (HIEs), and device and software vendors systems in the patient healthcare continuum

Healthcare professionals interact with the EHMS 124 to store and manage patient health/medical data 126. The patient health/medial data 126, in one embodiment, is stored within one or more electronic records 128, which are maintained within one or more databases 130. The database(s) 130 can be part of the EHMS 124, separate from the EHMS 124, reside on the server system 104, and/or reside on or across one or more remote information processing systems.

Healthcare professionals interact with the EHMS 124 to enter, store, and manage various medical and health related data/information associated with a given patient (or the user). For example, a healthcare professional can enter administrative and billing data, patient demographics, progress notes, vital signs, medical histories, diagnoses, medications, immunization dates, allergies, radiology images, lab and test results, and/or the like into the EHMS 124. The EHMS 124 stores this data 126 in one or more electronic records 128, as discussed above. Examples of electronic records 128 include EMRs, EHRs, PHRs, records generated by Practice Management Software Systems, records generated by HIEs, and/or any other types of electronic records generated within the patient healthcare continuum. It should be noted that the terms “Electronic Health Records” and “Electronic Medical Records” can be used interchangeably. EHRs and EMRs are systematic collections of electronic health information associated with a specific individual (patient) or population. An EHR comprises various types of information such as patient medical history, immunization status/history, lab results, medication and allergy information, radiology images, vital signs, personal statistics (e.g., age, weight, and height), demographics, billing information, and/or the like.

An EHR/EMR can be a patient record created in hospitals and ambulatory environments using an Electronic Health Management System (EHMS) 124 either on the network or residing locally at the hospital or ambulatory environment who created the record. An EHR/EMR is generally an internal record generated and maintained within an institution to give patients, physicians and other health care providers, employers, and payers or insurers access to a patient's medical records across facilities. An EHR/EMR software vendor produces software to manage Electronic Health Records for the health care providers use. A PHR is an online accessible health record that is maintained by the patient and comprises health data and information related to the care of the patient. The patient generally provides the information to be maintained by a PHR.

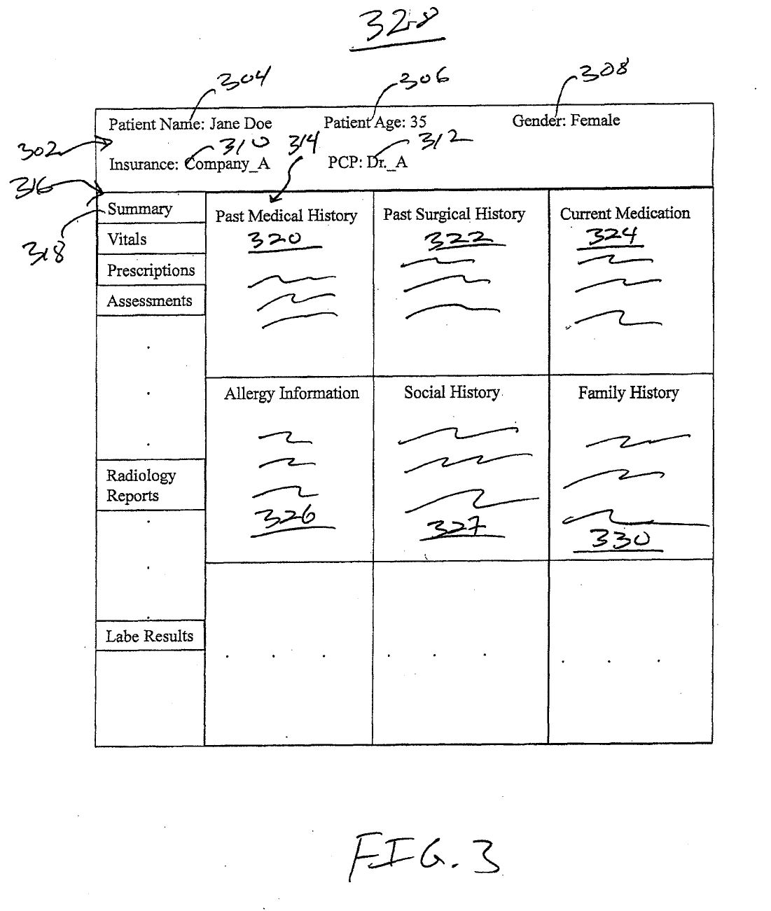

FIG. 3 shows one example of an electronic record(s) 328 generated by the EHMS 124 and displayed to a user of the interactive environment. In this example, the electronic record(s) 328 is an EHR. However, the EHMS 124 is not limited to only generating EHRs and can generate any type of electronic record associated with a patient. The EHR 328 comprises a first portion 302 displaying general patient data such as patient name 304, patient age 306, patient gender 308, patient insurance 310, patient primary care physician 312, and various other types of data. At least a second portion 314 of the EHR 328 displays either all of the health/medical related information associated with the patient or displays a portion of this information as selected by the user. For example, the EHR 328 can be associated with various sections each comprising different types of information such as vitals, lab results, radiology images/reports, prescriptions, assessments, and/or the like. The user is able to select a given section of the EHR 328 generally from a menu/tab option 316 displaying the various sections headings of the EHR 328. In the example shown in FIG. 3, the user has selected a summary section 318. This section 318 displays a patient summary comprising various types of medical/health related information such as past medical history 320, past surgical history 322, current medication 324, allergy information 326, social history 327, family history, 330, and/or the like. EHMSs and their interaction with the patient portal 110 are discussed in greater detail in the co-pending U.S. patent application Ser. No. ______, entitled “Automatic Generation Of Patient Presence For Patient Portals” filed on ______, which is hereby incorporated by reference in its entirety.

In addition to receiving health/medical data from an EHMS 124, the patient portal 110 also receives health/medical data from a user/patient. In this embodiment, the user/patient system 106 comprises a patient portal interface 132, an image capturing device(s) 134 (e.g., camera, scanner, etc.), an optional messaging module(s) 136, an optional web browser(s) 138, and one or more images 140 captured by the image capturing device 134. It should be noted that the messaging module 126 can be part of the portal interface 132 as well. It should be noted that the images 140 are not required to be stored on the user/patient system 106, and can be stored on a removable storage device, on and/or across one or more remote information processing systems, and/or the like.

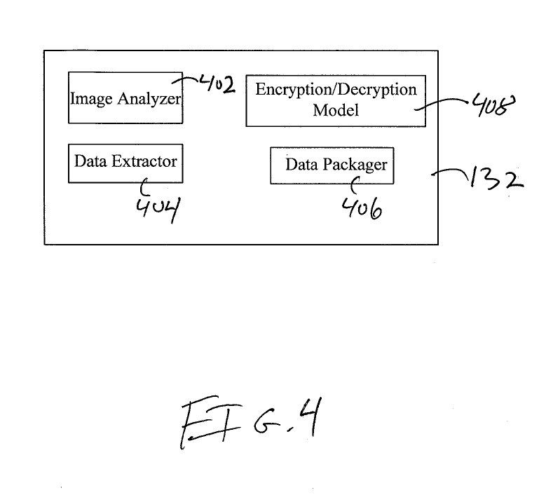

The patient portal interface 132, in one embodiment, is an application, a plug-in, and/or the like that allows a user/patient to transmit his/her health and medical related data to the patient portal 112. The patient portal interface 132, in one embodiment, comprises an image analyzer 402 (FIG. 4), a data extractor 404, a data packager 406, and an optional data encryption/decryption module 408. Each of these components is discussed in greater detail below. In one embodiment, the patient portal interface 132 is a standalone module. However, in other embodiments, the messaging module 136 and/or the web browser 138 implement the patient portal interface 132 (or are at least communicatively coupled to the interface 132).

In one embodiment, a user/patient utilizes her system or device 106 to capture one or more images 140 of her health or medical related data. For example, the user/patient can have health or medical related data in paper form such as lab results, doctors' records, prescriptions, radiology images, radiology reports, physical therapy treatment plans, hand written health or medical related information, and/or the like. The user/patient initiates the patient portal interface 110 to capture an image(s) 140 of this paper-based health or medical related information. It should be noted that embodiments of the present invention are not limited to capturing paper-based records/objects. For example, the image capturing device 134 can be a screen capturing program that captures an image of a screen comprising health and/or medical related information. This captured screen image can then be processed as discussed below.

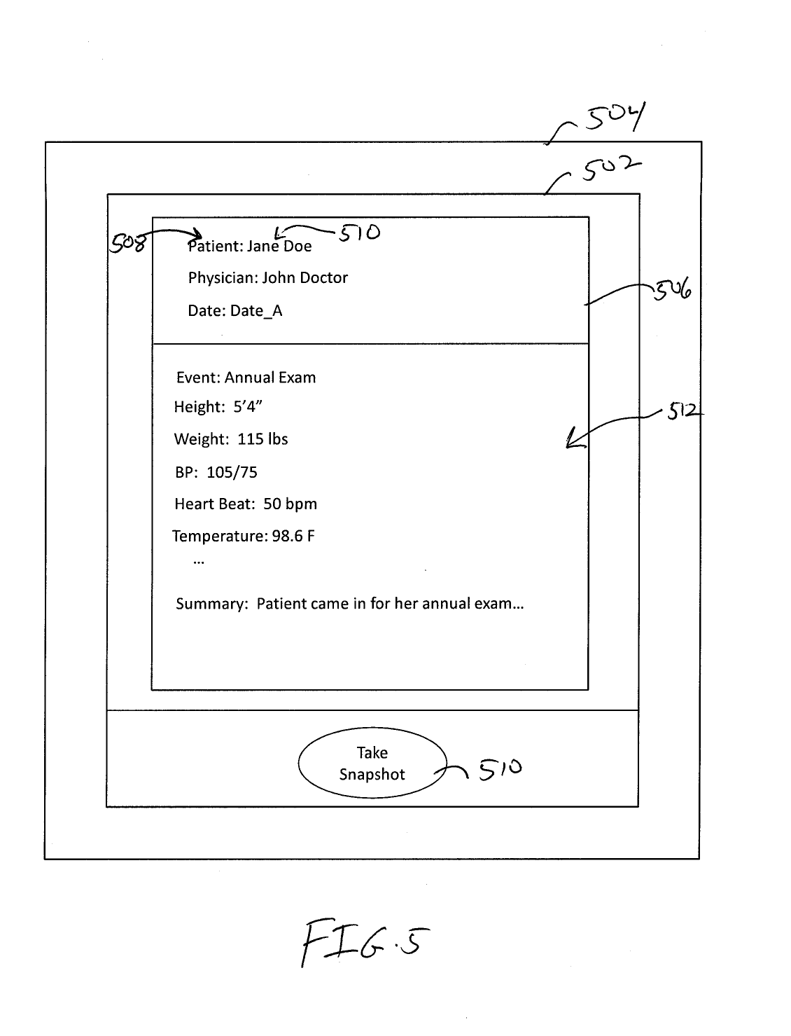

FIG. 5 shows one example of the patient portal interface 110. In this example, the patient portal interface 110 is an application that interfaces with the image capturing device 134 of the user/patient 104 (or communicatively coupled to the user/patient system 104). For example, the patient portal interface 110 can be an application executing on a mobile device of the user/patient. In the example shown in FIG. 5, the user/patient has initiated the portal interface 132 on her device 106. One or more windows 502 associated with the portal interface 110 are presented to the user/patient on the display 504 of the device 106. The image capturing device 134 (e.g., a camera) of the device 106 is also initiated, and objects within its field of view are presented to the user/patient via the portal interface window 502. The user/patient points the image capturing device 134 at an object comprising health or medical related information. In the example shown in FIG. 5, the user/patient has pointed the image capturing device 134 at a paper record 506 created by her doctor for an annual exam. The paper record comprises a plurality of fields 508 and field entries 510. It should be that the paper-based health and medical related information are not required to comprise fields, and can include data that is not associated with any fields. The user/patient then performs one or more actions (e.g., selects an icon 510) and the image capturing device 134 captures an image 140 of the paper record 506.

Once captured, the image analyzer 402 of the portal interface 110 analyzes the captured image 140. However, it should be noted that an image is not required to be captured and stored to be analyzed. For example, the image analyzer 402 is able to analyze an object within the field of view of the image capturing device 134 on-the-fly. The image analyzer 402 analyzes the image 140 to identify patient identifying information, healthcare provider and facility information, and/or health/medical related information. Once identified, the data extractor 404 extracts these data items from the image 140. For example, the image analyzer 402 utilizes one or more optical character recognition (OCR) engines to recognize various types of fields and data related to patient identifying information, healthcare provider and facility information, and/or health and medical related information.

In one embodiment, the image analyzer 420 identifies items such as characters, words, and sentences within the image 140, and compares these items to one or more templates, databases of keywords, and/or the like. It should be noted that the image analyzer 420 can also identify attributes associated with each identified item such as their semantics, formatting and/or placement within the image, the context in which the identified item was used, and/or the like. For example, consider an image 140 captured for the paper-based record 506 shown in FIG. 5. The image analyzer 420 utilizes one or more OCR or other image analysis engines analyze to analyze this image 140. Based on this analysis, the image analyzer 420 identifies the item “Patient: Jane Doe” from the image.

The image analyzer 420 compares this item to one or more record-based templates, databases of keywords, and/or the like and determines that this item is patient identifying information and identifies the patient Jane Doe who is associated with the record. For example, a record-based template can comprise various fields and information along with annotations identifying the field type, information type, and/or the like. The image analyzer 420 compares the identified item to one or more record-based templates to determine if the identified item matches any of the fields and/or information within the templates. If so, the image analyzer 402 utilizes the annotations or metadata associated with the matching template field/information to determine the type of field and/or type of information associated with the identified item.

In another example, the image analyzer 420 compares the identified item “Patient: Jane Doe” to a database of keywords. In this example, the keywords are also associated with metadata and/or annotations that identify the type of field and/or information associated with each keyword. For example, the database comprises keywords including “patient”, “height”, “weight”, etc. The keyword “patient” comprises metadata indicating that this type of data comprises the patient's name and is patient identifying information. The keywords “height” and “weight” comprise metadata indicating that this type of information is associated with a patient's vitals. It should be noted that the image analyzer 402 is also configured to identify patient identifying information, healthcare provider and facility information, and/or health/medical related information based on the semantics, context, and formatting of the identified items within an image 140.

If the image analyzer 402 is unable to identify whether an identified item is patient identifying information, healthcare provider and facility information, and/or health/medical related information, the patient portal interface 132 prompts the user to manually identify this item. The image analyzer 402 can also present the identified items and their determined types (e.g., patient identifying information, healthcare provider and facility information, and/or health/medical related information) to the user for verification of accuracy. The user is able to make any modifications to the items and their types as needed. Also, the image analyzer 402 can prompt the user to recapture an image of the paper-based record if it determines that the image quality of the current image 140 is below a given threshold.

After the image analyzer 402 has processed the image 140 and the data extractor 404 has extracted data items, the data packager 406 packages the extracted data items into one or more data packets/messages for transmission to the patient portal. In one embodiment, the extracted data is packaged/formatted as structured, semi-structured, and/or unstructured data (including attachments in binary form). For example, the data extracted from an image 140 of a paper-based record can be transmitted from the user system 106 as structured and/or unstructured data, a Continuation of Care Record (CCR), a Continuity of Care Document (CCD) or one of its equivalents/permutations, an unstructured clinical document architecture (CDA) record, and/or the like. It should be noted that embodiments of the present disclosure are not limited to such examples, and the extracted data can be transmitted to the patient portal 110 in any format.

CCRs and CCDs are both data sets conforming to specific health record standard specifications. A CCR comprises a summary of a patient's health status including medications, allergies, problems, insurance information, care plans, and/or the like. There are six sections of a CCR that have mandated core elements. These sections include a header, patient identifying information, patient financial and insurance information, health status of the patient, care documentation, and care plan recommendation. A CCD document comprises a dataset that conforms to an XML-based markup standard that specifies the semantics, encoding, and structure of a patient summary clinical document. A CCD comprises information such as the “Common MU Data Sets”, where “MU” stands for Meaningful Use. This data set comprises Patient name, sex, date of birth, race, ethnicity, preferred language, smoking status, problems, medications, medication allergies, laboratory tests, laboratory values/results, vital signs, care plan fields including goals and instructions, procedures and care team members. Other information such as referral reasons, discharge instructions, encounter diagnoses, and immunizations can also be included within a CCD.

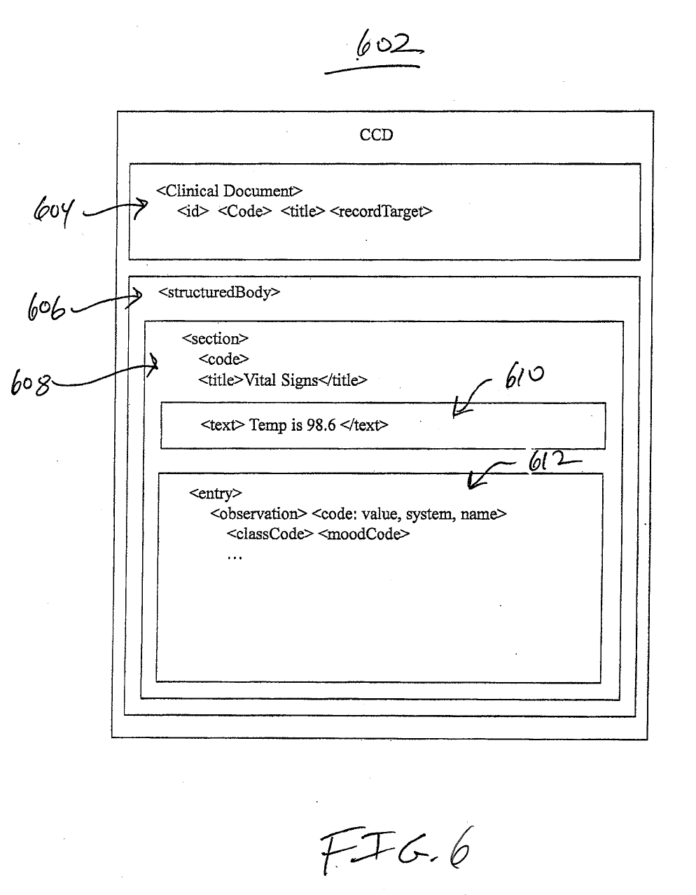

A CCD document is a human and machine-readable document comprising structured and, optionally, unstructured content. A CCD is generated according to the Clinical Document Architecture (CDA), which is an HL7 authored health care documentation standard. The CDA is a base standard that provides common architecture, coding, semantic framework, and markup language for the creation of electronic clinical documents. FIG. 6 shows one example of the structure and format of a CCD 602. In this example, the CCD comprises a header 604, a body 606, and one or more sections 608. The one or more sections 608 comprise a narrative block 610, and one or more entries 612.

The header 604 sets the context for the CCD as a whole. The header 604 allows management of the CCD and allows it to be exchanged across and within different institutions. Continuing with the example based on FIG. 5, the patient name “Jane Doe”, the physician's name “John Doctor”, and the date of the office visit “Date_A” are added to the header section of a CCD. The body 606 comprises the clinical report and can comprise structured content that is organized into one or more sections 608. The body 606 can also comprise an unstructured set of data as well. Each section 608 comprises a narrative block 610 and, optionally, one or more coded entries such as medications, allergies, immunizations, vital signs, and problems. Narrative blocks 610 provide human-readability of a CCD. The narrative block within a document section 608 represents the content to be rendered for viewing. For example, the event, height, weight, blood pressure, heart beat, and temperature data extracted from the image 140 of the paper-based record in FIG. 5 is included within a narrative of the CCD under a corresponding section (e.g., “Measurements”, “Vital Signs”, etc.)

Entries 612 provide machine-readability to the CCD. Entries 612 within a document section 608 represent structured content for further computer processing. The data packager 406 is able to generate a CCD using one or more CDA-based templates. The data packager 406 can select from one or more header templates, a body templates, and section templates, narrative block templates, and entry templates. Each of these templates is designed to satisfy a specific information exchange scenario and defines the CDA structures to be used to document the applicable clinical information.

Once the extracted data has been packaged, the patient portal interface 132 transmits the data to the patient portal 110 as data packets via a network adapter or encapsulated in one or more messages such as email messages, instant messages, Short Message Service (SMS) messages, Multimedia Messaging Service (MMS) messages, and/or the like via the messaging module 136. It should be noted that in other embodiments, the patient portal interface 132 does not perform any image processing and transmits the entire captured image 140 to the patient portal 110 for processing. In this embodiment, the patient portal 110 comprises an image analyzer (similar to that discussed above) that analyzes the image to identify patient identifying information, healthcare provider and facility information, and/or health/medical related information from the image 140. In another embodiment, the user/patient is able to upload the captured image 140 and/or its packaged extracted data to the patient portal 110 via the web browser 138.

In one embodiment, the extracted data (or the captured image 140) is transmitted to the patient portal 110 in an unsecure (e.g., unencrypted form or over an unsecure communication link) through the patient portal interface 132, messaging module 136, and/or the web browser 138. In another embodiment, the extracted data (or the captured image 140) is transmitted to the patient portal 110 via one or more secured mechanisms. For example, the portal interface 132 and the patient portal 110 are each associated with a security key pair that is used to encrypt/decrypt information being transmitted there between. In addition, the portal interface 132 and the patient portal 110 utilize one or more information exchange technologies such as DIRECT messaging (DIRECTProject.org), which provide secure messaging between sender and recipient parties, to transmit information between each other. For example, DIRECT messaging can be utilized to send secure emails, secure point-to-point messages (utilizing, for example, the Cross Enterprise Reliable Interchange (XDR) interface), and/or the like between the portal interface 132 and patient portal 110. Secure email utilizes the S/MIME standard for exchanging encrypted emails. With DIRECT messaging, certificates of the sending/receiving parties can be automatically discovered and retrieved across various networks such as the Internet.

In an embodiment where DIRECT messaging is to be used, the portal interface 132 and the patient portal 110 are each associated with a security key pair that is used to encrypt information being transmitted there between. The portal interface 132 and patient portal 110 can send secured messages directly to each other and/or through one or more third-party servers. In an embodiment, where third-party servers are utilized, the portal interface 132 and patient portal 110 are both part of the same or different secured/trust network such as those provided by Healthcare Information Service Providers (HISPs). In this embodiment, the portal interface 132 generates an electronic communication (e.g., email message) comprising the extracted data items (and any annotations identifying their information type) and/or the captured image 140 addressed to a DIRECT messaging address (e.g., DIRECT-messaging-based email address) of the patient portal 110. In one embodiment, the data items extracted from the image 140 is packaged in a CCR, CCD or unstructured CDA form; however this is not required. Also, an image 140 can be attached to an unstructured CDA that comprises patient identifying information associated with the user.

When utilizing DIRECT messaging, the portal interface 132, via the messaging module 136, sends the electronic communication to the patient portal 110 through at least one source trust server. This trust server receives the electronic communication and identifies the destination address, which is the messaging address of the portal interface 132. The trust server identifies the security certificate of the patient portal 110, generates an S/MIME-based message, and signs the message with the private key of the portal interface 132. The trust server further encrypts the message with the certificate (public key) of the patient portal 110 and sends this encrypted message to the patient portal 110.

The patient portal 110 can then receive the electronic communication in its encrypted form and perform decrypting operations itself. Alternatively, a destination trust server can intercept this encrypted communication and perform, for example, an S/MIME decryption process using the private key of the patient portal. After the communication and its content are decrypted, this trust server verifies the communication using a certificate (public key) of the portal interface 132. Once verified, the destination trust server sends the decrypted communication with its content to the patient portal 110 using its DIRECT messaging address. The patient portal 110 receives the communication from the portal interface 132 along with the electronic record/data in an unencrypted form.

In another embodiment, the third-party servers are not required. For example, the portal interface 132 and the patient portal 110 can securely communicate directly with each other. In one embodiment, the portal interface 132 utilizes standard web services protocols that transfer messages in a markup language format. These messages can be transmitted over HTTP or another protocol. The portal interface 132, in one embodiment, utilizes one or more security technologies such as SSL (Security Socket Layer) over HTTPS to securely communicate and encrypt the data exchange and communications between the portal interface 132 and the patient portal 110. The portal interface 132 utilizes one or more information exchange technologies such as DIRECT messaging to transmit electronic records to the portal interface 132.

In one embodiment, the portal interface 132 notifies the patient portal 110 that it would like to establish a secure communication link with the portal. Then, either the messaging module 136 or the communication manager 208 of the portal 110 establishes the requested secure communication link. It should be noted that this secure communication link can be established upon the user initiating the portal interface 132 to capture an image 140 of a paper-based record or upon receiving an indication from the user that he/she wants to transmit data to the patient portal 110.

When portal interface 132 of the EHMS 124 wants to establish a secure connection with the patient portal 110 it provides authentication information to the portal 110 to obtain a security token for that session period. For example, the portal interface 132 sends the following message to the patient portal 110:

<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>

<soap12:Body>
<AuthenticateInterface xmlns=“http://tempuri.org/”>
< UserLogin>string</ UserLogin>
<Password>string</Password>
</AuthenticateInterface>
</soap12:Body>

</soap12:Envelope>

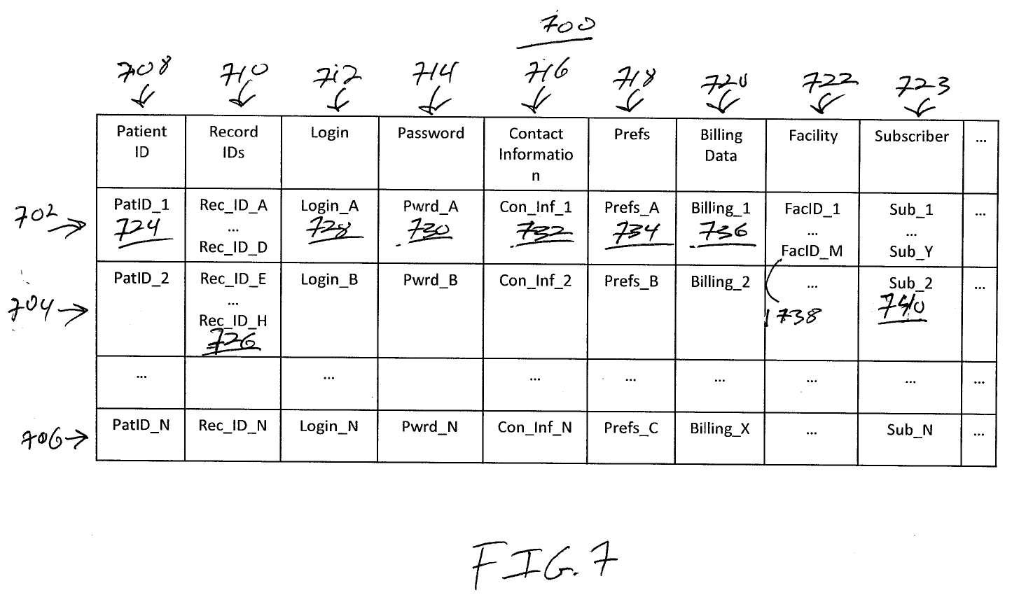

This message includes the login associated with the user for the patient portal 110 and the password associated with the user for the patient portal 110. The patient portal 110 receives this message and the communication manager 208 analyzes a set of user profiles 118 to determine if the requesting user has been previously registered with the portal 110. FIG. 7 shows various examples of user profiles 118. In the example shown in FIG. 7, each row 702, 704, 706 in the table 700 corresponds to a user profile. It should be noted that in other embodiments, each patient profile 702, 704, 706 is stored separate from one another. The table 700 comprises a plurality of columns, each storing a different set of information. In this example, the table 700 comprises a first column 708 entitled “Patient ID”; a second column 710 entitled “Record IDs”; a third column 712 entitled “Login”; a fourth column 714 entitled “Password”, a fifth column 716 entitled “Contact Information”; a sixth column 718 entitled “Preferences”; a seventh column 720 entitled “Billing Data”; and an eighth column 722 entitled “Facilities”.

The “Patient ID” column 708 comprises entries 724 uniquely identifying the user/patient associated with the user profile for the patient portal 110. The “Login” column 710 comprises entries 726 with the unique login or user name assigned to the user/patient for interacting with the patient portal 110. The “Record IDs” column 712 comprises entries 728 uniquely identifying each health/medical information record associated with the user and maintain stored by the patient portal 110. These record IDs can also point to a location where the records are stored. In one embodiment, these records are electronic records 128 received from the EHMS 124, records created by the patient portal 110 based on the data received from a user, records created by the patient portal 110 based the health/medical information within an electronic record 128 received from the EHMS 124, and/or the like. The patient portal 110 is able to receive electronic records 128 in various different formats, parse and extract their information, and generate its own electronic records 123 based on the extracted information. In this embodiment, the record IDs are associated with and/or pointing to the patient portal generated records 123.

The “Password” column 714 comprises entries 730 with the unique password assigned to the patient for interacting with the patient portal. The “Contact Information” column 716 comprises entries 732 identifying the contact information of the user/patient such as email addresses, home address, phone numbers, and/or the like. The “Preferences” column 718 comprises entries 734 that identify the user/patient preferences with respect to the patient portal. For example, the user/patient can configure how the patient portal 110 data presenter 204 presents information to the user/patient in the patient portal 110. In this example, the user/patient is able to select and configure the types of information that are displayed to the user/patient in the portal 110. Preferences can also include contact preferences and any other preferences that the user/patient is able to configure with respect to the patient portal 110. The “Billing Data” column 720 comprises entries 736 with various types of billing data associated with the patient (if applicable). Examples of billing data include subscription plan type, payment information, payment histories, and/or the like. The “Facility” column 722 comprises entries 738 with the facility ID (or a pointer to the subscriber profile 120) of each facility associated with the patient.

Once the patient portal 110 receives an authentication request message from the portal interface 132, the communication manager 208 analyzes the user profiles 118 to determine if any of the profiles comprises a login matching the facility ID within the authentication request message. If a match exists, the communication manager 208 further analyzes the profiles 118 to determine if the password transmitted within the authentication request message matches the information within the identified profile. Based on this analysis, the communication manager 208 transmits a response message back to the portal interface 132 either granting the authentication request or denying it. For example, the communication manager 208 sends the following message to the portal interface 132:

<?xml version=“1.0” encoding=“utf-8”?>
<soap12:Envelope
xmlns:xsi=“http://www.w3.org/2001/XMLSchema-instance”
xmlns:xsd=“http://www.w3.org/2001/XMLSchema”
xmlns:soap12=“http://www.w3.org/2003/05/soap-envelope”>

<soap12:Body>
<AuthenticateInterfaceResponse xmlns=“http://tempuri.org/”>
<AuthenticateInterfaceResult>
<Valid>boolean</Valid>
<Token>string</Token>
<ErrorMessage>string</ErrorMessage>
</AuthenticateInterfaceResult>
</AuthenticateInterfaceResponse>
</soap12:Body>

</soap12:Envelope>

The above message comprises a “Valid” value if the request from the portal interface 132 was successfully processed; otherwise a “False” value is returned. If the request could not be successfully processed, the message also comprises an error message indicating the reason why the request was denied. If the request was successfully processed the communication manager 208 also sends a security token for the transmission to the portal interface 132. It should be noted that, in one embodiment, the user is required to login to the portal interface 132. In this embodiment, above authentication process is performed when the user logs into the portal interface 132. The portal interface 132 can either locally authenticate the user or have the patient portal 110 authenticate the user as discussed above. If the user is authenticated by the portal interface 132, the patient portal 110 authenticates the portal interface 132 (e.g., based on an identifier associated with the portal interface 132) when establishing a secure communication link with the portal interface 132. In another embodiment, the user is authenticated by the portal interface 132 and/or the patient portal 110, and the portal interface 132 is authenticated by the patient portal 110.

Once the portal interface 132 has obtained its security token, it is able to securely transmit its data to the patient portal 110 over the secured link. For example, the portal interface 132 generates one or more messages/packets comprising the data items extracted from an image 140 (or the image itself). The extracted (and/or the image) can be packaged as a CCR, CCD, unstructured CDA, and/or the like; however this is not required. The message can also comprise an identifier associated with the user and/or the portal interface 132. However, if a communication link has been established for transmitting the message the user identifier and/or interface identifier is not required. For example, this link can be associated with the user and/or portal interface 132 so that any data received by the portal 110 over this link is known to be associated with the user and/or portal interface 132.

The encryption/decryption module 408 encrypts the communication with the public key of the patient portal 110 and signs the communication with the private key of the portal interface 132. The portal interface 132 then sends the encrypted communication to the patient portal 110 via secure communication link. It should be noted that the extracted data items (and/or the image 140) are not required to be encrypted prior to being sent to the patient portal 110 since the secure communication link provides an encrypted pipe such that the messages are securely encapsulated when being transmitted to the patient portal 110.

In another embodiment, a secure communication link is not established between the portal interface 132 and patient portal 110. In this embodiment, the encryption/decryption module 408 of the portal interface 132 securely encrypts the extracted data items (and/or the image 140) prior to transmitting them to the patient portal 110. In this embodiment, the portal interface 132 generates a message/packet comprising the encrypted data and sends the message to a messaging address (e.g., email address) of the patient portal 110. In another embodiment, the portal interface 132 transmits data to the patient portal 110 in an unsecured form over an unsecured link. It should be noted that embodiments of the present disclosure are not limited to the above examples directed to securely transmitting electronic record data to the patient portal 110. Other mechanisms for securely transmitting electronic record data to the patient portal 110 are applicable as well.

When the patient portal 110 receives a secured transmission (e.g., an encrypted message) from the EHMS 124, the encryption/decryption module 206 decrypts the message (e.g., using its private key). The communication manager 210 can then optionally verify that the message was actually sent by the EHMS 124 by checking the message's secure signature. In other embodiments, the patient portal 110 receives an unencrypted DIRECT message from the portal interface 132 at its protected DIRECT messaging address. This message has been previously decrypted and verified by a third-party authentication/trust server, as discussed above.

The communication manager 210 analyzes the contents of a received message/communication to identify the user associated with the health-related data within the message/communication. In one embodiment, the data items (or the image 140) transmitted in the message received from the portal interface 132 comprises user identifying information such as the user's name, address, phone number, email address, patient ID for the healthcare facility, user ID for the patient portal (if previously registered), and/or any other type of information that can be used to uniquely identify the user. The communication manager 210 compares the user identifying information to information in one or more user profiles 118. Based on this comparison, the communication manager 208 determines if the user is associated with an account (has been previously registered) for the patient portal 110. If so, the communication manager 208 stores the received data items extracted from a captured image of a paper-based record and links them to the user's account. For example, the profile manager 202 creates a patient portal record 122 comprising this received data (e.g., health/medical data 120). The user's profile 116 is then updated to include the ID of this record 122. Once the data received from the portal interface 132 is linked to the user's account, the user is able to login into the patient portal and interact with this data. One example of how health/medical data 120 and records 120 are stored by the patient portal 110 based on receiving communications from a user (and an EHMS 124), and how users can interact with this data 120 or records 120 at the portal 110 is provided in the co-pending U.S. patent application Ser. No. ______, entitled “Electronic Management Of Patient Health Care Data” filed on ______, which is hereby incorporated by reference in its entirety.

The portal manager 114 can also analyze the data items received in the communication from the portal interface 132 to identify the healthcare facility (if any) associated with paper-based record. The profile manager 202 updates the “Facilities” column 722 in the user profile 118 of the user to identify this identified facility. In embodiments where the communication manager 208 determines that the user or facility does not have an account with the patient portal 110, the portal manager 114 automatically creates an account/presence for the user and/or facility as discussed in the commonly owned U.S. Provisional patent application Ser. No. ______, entitled “Automatic Generation Of Patient Presence For Patient Portals” filed on ______, which has been incorporated by reference in its entirety.

Operational Flow Diagrams

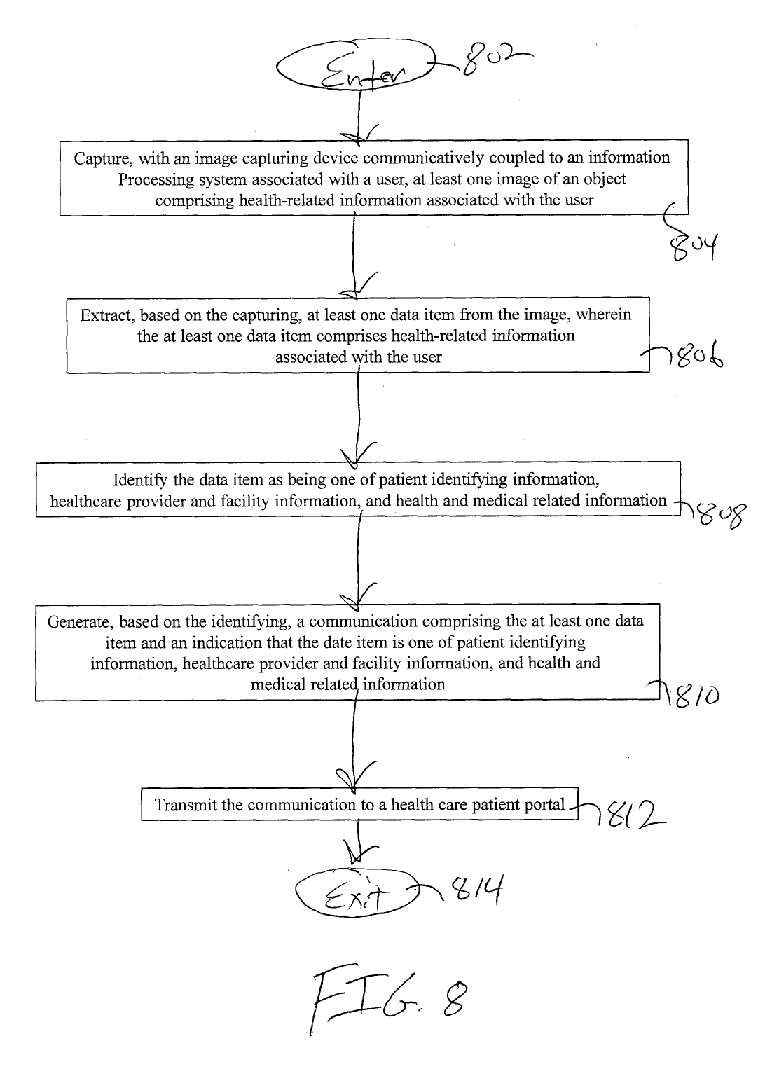

FIG. 8 is an operational flow diagram illustrating one example of an overall process for remotely capturing user health-related information for transmission to a patient portal. The operational flow of FIG. 8 beings a step 802 and flows directly to step 804. The portal interface 132, at step 804, captures at least one image 140 of an object comprising health-related information associated with a user. The capturing is performed with an image capturing device communicatively coupled to an information processing system 106 associated with the user. The portal interface 132, at step 806, extracts at least one data item from the image 140 based on the capturing. The at least one data item comprises health-related information associated with the user.

The portal interface 132, at step 808, identifies the data item as being one of patient identifying information, healthcare provider and facility information, and health and medical related information. The portal interface 132, at step 810, generates a communication based on the identifying. The communication comprises at least one data item and an indication that the data item is one of patient identifying information, healthcare provider and facility information, and health and medical related information. The portal interface 132, at step 812, transmits the communication to a patient portal 110. The control flow exits at step 814.

Information Processing System

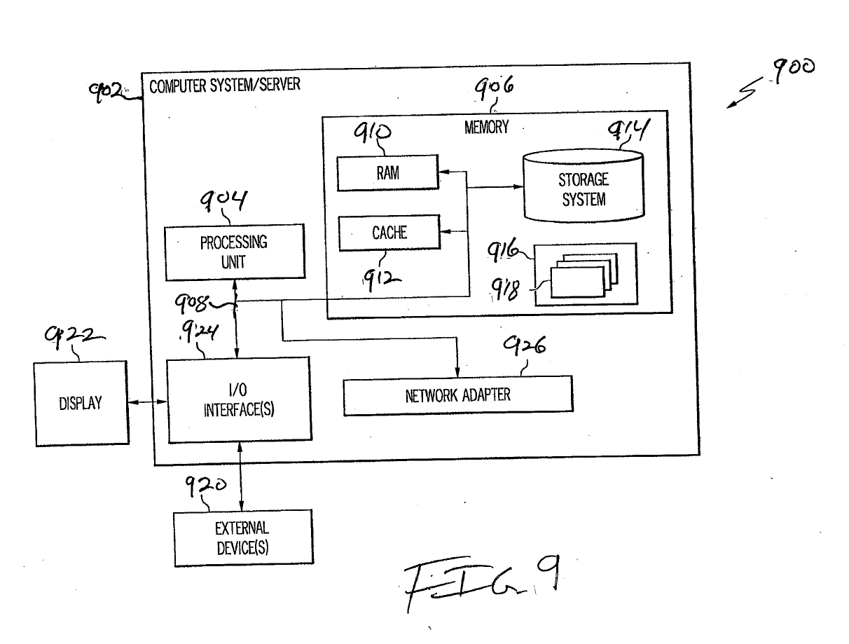

FIG. 9 shows a block diagram illustrating an information processing system 900 that can be utilized in various embodiments of the present disclosure such as the information processing system 102 shown in FIG. 1. The information processing system 902 is based upon a suitably configured processing system configured to implement one or more embodiments of the present disclosure. Any suitably configured processing system can be used as the information processing system 902 in embodiments of the present disclosure. The components of the information processing system 902 can include, but are not limited to, one or more processors or processing units 904, a system memory 906, and a bus 908 that couples various system components including the system memory 906 to the processor 904.

The bus 908 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 9, the main memory 906 includes at the patient portal 110, its components, the user profiles 116, the facility profiles 118, and the subscriber profiles 119 shown in FIG. 1. The portal manager 114 can reside within the processor 904, or be a separate hardware component. The system memory 906 can also include computer system readable media in the form of volatile memory, such as random access memory (RAM) 910 and/or cache memory 912. The information processing system 902 can further include other removable/non-removable, volatile/non-volatile computer system storage media. By way of example only, a storage system 914 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 908 by one or more data media interfaces. The memory 906 can include at least one program product having a set of program modules that are configured to carry out the functions of an embodiment of the present disclosure.

Program/utility 916, having a set of program modules 918, may be stored in memory 906 by way of example, and not limitation, as well as an operating system, one or more application programs, other program modules, and program data. Each of the operating system, one or more application programs, other program modules, and program data or some combination thereof, may include an implementation of a networking environment. Program modules 918 generally carry out the functions and/or methodologies of embodiments of the present disclosure.

The information processing system 902 can also communicate with one or more external devices 920 such as a keyboard, a pointing device, a display 922, etc.; one or more devices that enable a user to interact with the information processing system 902; and/or any devices (e.g., network card, modem, etc.) that enable computer system/server 902 to communicate with one or more other computing devices. Such communication can occur via I/O interfaces 924. Still yet, the information processing system 902 can communicate with one or more networks such as a local area network (LAN), a general wide area network (WAN), and/or a public network (e.g., the Internet) via network adapter 926. As depicted, the network adapter 926 communicates with the other components of information processing system 902 via the bus 908. Other hardware and/or software components can also be used in conjunction with the information processing system 902. Examples include, but are not limited to: microcode, device drivers, redundant processing units, external disk drive arrays, RAID systems, tape drives, and data archival storage systems.

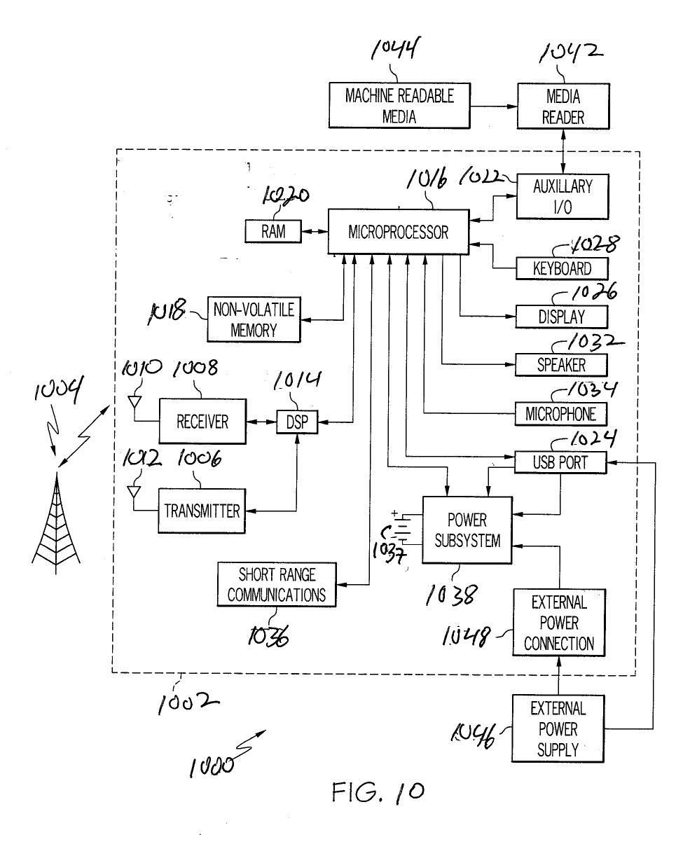

FIG. 10 is a block diagram of a portable electronic device and associated components 1000 in which the systems and methods disclosed herein may be implemented. In this example, a portable electronic device 1002 is the user system 106 of FIG. 1 and is a wireless two-way communication device with voice and data communication capabilities. Such electronic devices communicate with a wireless voice or data network 1004 using a suitable wireless communications protocol. Wireless voice communications are performed using either an analog or digital wireless communication channel. Data communications allow the portable electronic device 1002 to communicate with other computer systems via the Internet. Examples of electronic devices that are able to incorporate the above described systems and methods include, for example, a data messaging device, a two-way pager, a cellular telephone with data messaging capabilities, a wireless Internet appliance or a data communication device that may or may not include telephony capabilities.

The illustrated portable electronic device 1002 is an example electronic device that includes two-way wireless communications functions. Such electronic devices incorporate communication subsystem elements such as a wireless transmitter 1006, a wireless receiver 1008, and associated components such as one or more antenna elements 1010 and 1012. A digital signal processor (DSP) 1014 performs processing to extract data from received wireless signals and to generate signals to be transmitted. The particular design of the communication subsystem is dependent upon the communication network and associated wireless communications protocols with which the device is intended to operate.

The portable electronic device 1002 includes a microprocessor 1016 that controls the overall operation of the portable electronic device 1002. The microprocessor 1016 interacts with the above described communications subsystem elements and also interacts with other device subsystems such as non-volatile memory 1018 and random access memory (RAM) 1020. The non-volatile memory 1018 and RAM 1020 in one example contain program memory and data memory, respectively. Also, the power supply profiles 116, notification rules/preferences 124, and historical information 132 can be stored in the non-volatile memory 1018 as well. The microprocessor 1016 also interacts with an auxiliary input/output (I/O) device 1022, a Universal Serial Bus (USB) Port 1024, a display 1026, a keyboard 1028, a speaker 1032, a microphone 1034, a short-range communications subsystem 1036, a power subsystem 1038, and any other device subsystems.

A power supply 1037, such as a battery, is connected to a power subsystem 1038 to provide power to the circuits of the portable electronic device 1002. The power subsystem 1038 includes power distribution circuitry for providing power to the portable electronic device 1002 and also contains battery charging circuitry to manage recharging the battery power supply 1037. The power subsystem 1038 includes a battery monitoring circuit that is operable to provide a status of one or more battery status indicators, such as remaining capacity, temperature, voltage, electrical current consumption, and the like, to various components of the portable electronic device 1002. The power management subsystem 1038 may also include the power management system 104 as well. An external power supply 1046, such as the charging device 120 discussed above, is able to be connected to an external power connection 1048.

The USB port 1024 further provides data communication between the portable electronic device 1002 and one or more external devices. Data communication through USB port 1024 enables a user to set preferences through the external device or through a software application and extends the capabilities of the device by enabling information or software exchange through direct connections between the portable electronic device 1002 and external data sources rather than via a wireless data communication network.

Operating system software used by the microprocessor 1016 is stored in non-volatile memory 1018. Further examples are able to use a battery backed-up RAM or other non-volatile storage data elements to store operating systems, other executable programs, or both. The operating system software, device application software, or parts thereof, are able to be temporarily loaded into volatile data storage such as RAM 1020. Data received via wireless communication signals or through wired communications are also able to be stored to RAM 1020. As an example, a computer executable program configured to perform the power management and charging device detection process 800, described above, is included in a software module stored in non-volatile memory 1018.

The microprocessor 1016, in addition to its operating system functions, is able to execute software applications on the portable electronic device 1002. A predetermined set of applications that control basic device operations, including at least data and voice communication applications, is able to be installed on the portable electronic device 1002 during manufacture. Examples of applications that are able to be loaded onto the device may be a personal information manager (PIM) application having the ability to organize and manage data items relating to the device user, such as, but not limited to, e-mail, calendar events, voice mails, appointments, and task items. Further applications include applications that have input cells that receive data from a user.

Further applications may also be loaded onto the portable electronic device 1002 through, for example, the wireless network 1004, an auxiliary I/O device 1022, USB port 1024, short-range communications subsystem 1036, or any combination of these interfaces. Such applications are then able to be installed by a user in the RAM 1020 or a non-volatile store for execution by the microprocessor 1016.

In a data communication mode, a received signal such as a text message or web page download is processed by the communication subsystem, including wireless receiver 1008 and wireless transmitter 1006, and communicated data is provided the microprocessor 1016, which is able to further process the received data for output to the display 1026, or alternatively, to an auxiliary I/O device 1022 or the USB port 1024. A user of the portable electronic device 1002 may also compose data items, such as e-mail messages, using the keyboard 1028, which is able to include a complete alphanumeric keyboard or a telephone-type keypad, in conjunction with the display 1026 and possibly an auxiliary I/O device 1022. Such composed items are then able to be transmitted over a communication network through the communication subsystem.

For voice communications, overall operation of the portable electronic device 1002 is substantially similar, except that received signals are generally provided to a speaker 1032 and signals for transmission are generally produced by a microphone 1034. Alternative voice or audio I/O subsystems, such as a voice message recording subsystem, may also be implemented on the portable electronic device 1002. Although voice or audio signal output is generally accomplished primarily through the speaker 1032, the display 1026 may also be used to provide an indication of the identity of a calling party, the duration of a voice call, or other voice call related information, for example.

Depending on conditions or statuses of the portable electronic device 1002, one or more particular functions associated with a subsystem circuit may be disabled, or an entire subsystem circuit may be disabled. For example, if the battery temperature is low, then voice functions may be disabled, but data communications, such as e-mail, may still be enabled over the communication subsystem.

A short-range communications subsystem 1036 provides for communication between the portable electronic device 1002 and different systems or devices, which need not necessarily be similar devices. For example, the short-range communications subsystem 1036 may include an infrared device and associated circuits and components or a Radio Frequency based communication module such as one supporting Bluetooth® communications, to provide for communication with similarly-enabled systems and devices. Additionally, while examples of the present disclosure have been discussed as using two-way wireless communication, in some embodiments, the short-range communications subsystem 1036 may alternatively operate as a one-way wireless communication system that wirelessly receives transmissions from other compatible wireless transmitter enabled systems and devices. In alternative embodiments one-way wireless communications may be used to allow the user device (portable electronic device) 106 to communicate with other devices, such as to wirelessly detect nearby power supply charging devices.

A media reader 1042 is able to be connected to an auxiliary I/O device 1022 to allow, for example, loading computer readable program code of a computer program product into the portable electronic device 1002 for storage into non-volatile memory 1018. In one example, computer readable program code includes instructions for performing the power management and charging device detection process 800, described above. One example of a media reader 1042 is an optical drive such as a CD/DVD drive, which may be used to store data to and read data from a computer readable medium or storage product such as computer readable storage media 1044. Examples of suitable computer readable storage media include optical storage media such as a CD or DVD, magnetic media, or any other suitable data storage device. Media reader 1042 is alternatively able to be connected to the electronic device through the USB port 1024 or computer readable program code is alternatively able to be provided to the portable electronic device 1002 through the wireless network 1004.

### Non-Limiting Examples

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”,” “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. Also, the phrase “such as” is not intended to limit the disclosure to any particular item being referred to. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for remotely capturing user health-related information, the method comprising:
capturing, with an image capturing device communicatively coupled to an information processing system associated with a user, at least one image of an object comprising health-related information associated with the user;
extracting, based on the capturing, at least one data item from the image, wherein the at least one data item comprises health-related information associated with the user;
identifying the data item as being one of patient identifying information, healthcare provider and facility information, and health and medical related information;
generating, based on the identifying, a communication comprising the at least one data item and an indication that the data item is one of patient identifying information, healthcare provider and facility information, and health and medical related information; and
transmitting the communication to a health care patient portal.

2. The method of claim 1, wherein the image capturing device is a camera and the information processing system is a wireless communication device.

3. The method of claim 1, wherein identifying the at least one data item from the image comprises:
performing optical character recognition on the data item;
recognizing at least one of characters, words, and sentences within the data item;
comparing the at least one of characters, words, and sentences to at least one of a set of record-based templates and a set of keywords, wherein each of the set of record-based templates and the set of keywords are associated with a set of metadata, wherein the metadata identifies an information type associated with a set of fields within each of the set of record-based templates and an information type associated with each of the set of keywords, wherein the information type is one of patient identifying information, healthcare provider and facility information, and health and medical related information;
determining, based on the comparing, that the at least one of characters, words, and sentences matches at least one of
a field within one of the set of record-based templates, and
a keyword in the set of keywords; and
identifying, based on the determining, that that the at least one of characters, words, and sentences is one of patient identifying information, healthcare provider and facility information, and health and medical related information.

4. The method of claim 1, wherein generating the communication comprises generating one of a continuity of care document, a continuity of care record, and an unstructured clinical document architecture record.

5. The method of claim 1, wherein the transmitting comprises:
identifying a DIRECT messaging address of the health care patient portal from the message; and
transmitting the communication to the DIRECT messaging address that has been identified.

6. The method of claim 1, wherein the transmitting comprises:
establishing a secure communication link with the health care patient portal; and
transmitting the communication to the health care patient portal over the secure communication link.

7. The method of claim 1, further comprising:
receiving a request from the user to execute a patient portal interface;
executing, based on receiving the request, the patient portal interface;
determining that the user is authorized to interact with the patient portal interface;
transmitting, based on the determining, a set of credentials to the health care patient portal;
receiving an indication from the health care patient portal that at least one of the user and the patient portal interface has been authenticated based on the set of credentials; and
establishing, based on receiving the indication, a secure communication link with the health care patient portal.

8. The method of claim 1, wherein the communication comprises an unstructured clinical document architecture record, wherein the unstructured clinical document architecture record comprises at least patient identifying information associated with the user and the image in binary form.

9. An information processing system for remotely capturing user health-related information, the information processing system comprising:
memory;
a processor communicatively coupled to the memory; and
a health care patient portal interface communicatively coupled to the memory and the processor, wherein the health care patient portal interface is configured to perform a method comprising:
capturing, with an image capturing device, at least one image of an object comprising health-related information associated with a user;
extracting, based on the capturing, at least one data item from the image, wherein the at least one data item comprises health-related information associated with the user;
identifying the data item as being one of patient identifying information, healthcare provider and facility information, and health and medical related information;
generating, based on the identifying, a communication comprising the at least one data item and an indication that the data item is one of patient identifying information, healthcare provider and facility information, and health and medical related information; and
transmitting the communication to a health care patient portal.

10. The information processing system of claim 9, wherein the image capturing device is a camera and the information processing system is a wireless communication device.

11. The information processing system of claim 9, wherein identifying the at least one data item from the image comprises:
performing optical character recognition on the data item;
recognizing at least one of characters, words, and sentences within the data item;
comparing the at least one of characters, words, and sentences to at least one of a set of record-based templates and a set of keywords, wherein each of the set of record-based templates and the set of keywords are associated with a set of metadata, wherein the metadata identifies an information type associated with a set of fields within each of the set of record-based templates and an information type associated with each of the set of keywords, wherein the information type is one of patient identifying information, healthcare provider and facility information, and health and medical related information;
determining, based on the comparing, that the at least one of characters, words, and sentences matches at least one of
a field within one of the set of record-based templates, and
a keyword in the set of keywords; and
identifying, based on the determining, that that the at least one of characters, words, and sentences is one of patient identifying information, healthcare provider and facility information, and health and medical related information.

12. The information processing system of claim 9, wherein generating the communication comprises generating one of a continuity of care document, a continuity of care record, and an unstructured clinical document architecture record.

13. The information processing system of claim 9, wherein the transmitting comprises:
identifying a DIRECT messaging address of the health care patient portal from the message; and
transmitting the communication to the DIRECT messaging address that has been identified.

14. A computer program storage product for remotely capturing user health-related information, the computer program storage product comprising instructions configured to perform a method comprising:
capturing, with an image capturing device communicatively coupled to an information processing system associated with a user, at least one image of an object comprising health-related information associated with the user;
extracting, based on the capturing, at least one data item from the image, wherein the at least one data item comprises health-related information associated with the user;
identifying the data item as being one of patient identifying information, healthcare provider and facility information, and health and medical related information;
generating, based on the identifying, a communication comprising the at least one data item and an indication that the data item is one of patient identifying information, healthcare provider and facility information, and health and medical related information; and
transmitting the communication to a health care patient portal.

15. The computer program storage product of claim 14, wherein the image capturing device is a camera and the information processing system is a wireless communication device.

16. The computer program storage product of claim 14, wherein identifying the at least one data item from the image comprises:
performing optical character recognition on the data item;
recognizing at least one of characters, words, and sentences within the data item;
comparing the at least one of characters, words, and sentences to at least one of a set of record-based templates and a set of keywords, wherein each of the set of record-based templates and the set of keywords are associated with a set of metadata, wherein the metadata identifies an information type associated with a set of fields within each of the set of record-based templates and an information type associated with each of the set of keywords, wherein the information type is one of patient identifying information, healthcare provider and facility information, and health and medical related information;
determining, based on the comparing, that the at least one of characters, words, and sentences matches at least one of
a field within one of the set of record-based templates, and
a keyword in the set of keywords; and
identifying, based on the determining, that that the at least one of characters, words, and sentences is one of patient identifying information, healthcare provider and facility information, and health and medical related information.

17. The computer program storage product of claim 14, wherein generating the communication comprises generating one of a continuity of care document, a continuity of care record, and an unstructured clinical document architecture record.

18. The computer program storage product of claim 14, wherein the transmitting comprises:
identifying a DIRECT messaging address of the health care patient portal from the message; and
transmitting the communication to the DIRECT messaging address that has been identified.

19. The computer program storage product of claim 14, wherein the transmitting comprises:
establishing a secure communication link with the health care patient portal; and
transmitting the communication to the health care patient portal over the secure communication link.

20. The computer program storage product of claim 14, wherein the method further comprises:
receiving a request from the user to execute a patient portal interface;
executing, based on receiving the request, the patient portal interface;
determining that the user is authorized to interact with the patient portal interface;
transmitting, based on the determining, a set of credentials to the health care patient portal;
receiving an indication from the health care patient portal that at least one of the user and the patient portal interface has been authenticated based on the set of credentials; and
establishing, based on receiving the indication, a secure communication link with the health care patient portal.
